(19) United States
(12) Patent Application Publication
(10) Pub. No.: US 2025/0210883 A1
(43) Pub. Date: Jun. 26, 2025

(54) SYSTEM, METHOD AND APPARATUS FOR HIGH-SPEED WIRELESS COMMUNICATION THROUGH HIGH-LOSS OBSTRUCTION

(71) Applicant: Airvine Scientific, Inc., Santa Clara, CA (US)

(72) Inventors: David Bruce Isaksen, San Jose, CA (US); Morteza Sheikhsofla, San Jose, CA (US); Ehsan Afshari, Ann Arbor, MI (US); Darin Milton, Campbell, CA (US)

(73) Assignee: Airvine Scientific, Inc., Santa Clara, CA (US)

(21) Appl. No.: 18/985,805

(22) Filed: Dec. 18, 2024

Related U.S. Application Data
(60) Provisional application No. 63/613,401, filed on Dec. 21, 2023.

(51) Int. Cl. H01Q 21/24; H04B 7/0413; H04L 27/34

(52) U.S. Cl. CPC H01Q 21/24; H04B 7/0413; H04L 27/34

(57) ABSTRACT

Disclosed are one or more apparatuses, systems and methods that allow microwave communications signals to pass efficiently and reliably through high-loss obstructions, such as concrete structures. For example, a concrete-penetrating microwave apparatus includes a wireless microwave transceiver coupled to a multiple input multiple output (MIMO) antenna. The transceiver processes wireless microwave signals transmitted and received by the MIMO antenna through one or more obstructions. The MIMO antenna and transceiver are configured to compensate for path loss experienced by the microwave signals as they pass through the lossy obstruction so as to maintain the desired data rate of the wireless microwave signals. Concrete-penetrating microwave apparatuses may be paired together and aimed at each other, with one apparatus on either side of an obstruction, to allow high-speed networked microwave communication directly through the otherwise microwave-impenetrable obstruction. This permits high-bandwidth communications throughout buildings or other structures without having to install expensive wall/floor-penetrating cable.

### CROSS REFERENCE TO RELATED APPLICATIONS

This Application claims the benefit of U.S. Provisional Patent Application Ser. No. 63/613,401, filed on Dec. 21, 2023, which is incorporated by reference herein in its entirety. This application is also related to U.S. Pat. No. 11,784,850 (‘'850 patent”), entitled “High-Speed Wireless Multi-Path Data Network,” which is incorporated by reference herein in its entirety.

### TECHNICAL FIELD

This disclosure generally relates to wireless communications, and more particularly, to wireless communication networks capable of operating in the Wi-Fi microwave spectrums.

### BACKGROUND

The 2.4 GHz, 5 GHz and 6 GHz Wi-Fi microwave spectrums can be used for high-speed wireless communications as described by the latest IEEE 802.11ax and IEEE 802.11be standards. Regulatory authorities in many countries permit unlicensed operation in the 2.4 GHz, 5 GHz and 6 GHz Wi-Fi bands.

A problem with wireless networks is the ability for wireless signals to penetrate obstructions, such as walls or floors within buildings or other barriers. Although microwave signals can pass through some obstructions, they are often degraded by doing so. Degradation may be due to attenuation (in various materials), reflections and other physical processes caused by the obstruction. As the frequency of transmission increases, attenuation by obstacles and free space also increases. The result is a reduction of received power, thereby limiting the signal range, data rates and the ability to penetrate obstructions.

It is desirable that high-speed wireless networks operate successfully within buildings and other environments where obstructions and free space distances may present potential limitations. It is also desirable that such networks operate reliably and securely.

### SUMMARY

Disclosed herein are one or more apparatuses, systems and methods that allow microwave communication signals to pass efficiently and reliably through lossy obstructions, such as concrete walls, concrete floors, bricks, glass, free space and other barriers, resulting in significantly improved performance of the wireless microwave communication within a building, through a building, buildings, or other structures or obstructions.

A disclosed exemplary apparatus capable of microwave wireless communications through one or more obstructions includes a wireless transceiver and a microwave-frequency multiple-input multiple-output (MIMO) antenna coupled to the wireless transceiver. The radio frequency (RF) transceiver is configured to process the wireless microwave signals transmitted and received by the MIMO antenna. The MIMO antenna is configured to transmit and receive wireless microwave signals through a physical obstruction. The obstruction includes one or more materials that attenuate the strength of wireless microwave signals passing through the obstruction, for example, concrete, rebar, a combination of concrete and rebar, or other lossy material(s) in the microwave spectrum, alone or in combination. The MIMO antenna and the transceiver are configured together to compensate for path loss experienced by the microwave signals passing through the physical obstruction so as to maintain a desired data rate of the wireless microwave signals.

A disclosed exemplary system capable of microwave wireless communications through one or more obstructions includes a first apparatus and a second apparatus located on an opposite side of a physical obstruction from the first apparatus. The obstruction includes one or more materials that reduce the strength of the wireless microwave signals passing through the obstruction. For example, the materials may include concrete, rebar, a combination of concrete and rebar, or other lossy material(s) in the microwave spectrum, alone or in combination. The first apparatus includes a first microwave-frequency MIMO antenna configured to transmit and receive wireless microwave signals through the obstruction and a first RF transceiver, coupled to the first MIMO antenna, configured to process the wireless microwave signals transmitted and received by the first MIMO antenna. The first MIMO antenna and the first RF transceiver are configured to compensate for path loss experienced by the microwave signals passing through the obstruction so as to maintain a desired data rate of the wireless microwave signals. The second apparatus includes a second microwave-frequency MIMO antenna configured to transmit and receive the wireless microwave signals through the obstruction and a second RF transceiver, coupled to the second MIMO antenna, configured to process the wireless microwave signals transmitted and received by the second MIMO antenna. The second MIMO antenna and the second RF transceiver are configured to compensate for the path loss experienced by the microwave signals passing through the obstruction so as to maintain the data rate of the wireless microwave signals.

An example method of wireless communication is also disclosed. The method includes configuring a first microwave-frequency MIMO antenna and a first RF transceiver, coupled to the first MIMO antenna, to compensate for path loss experienced by one or more microwave signals passing through a physical obstruction so as to maintain a desired data rate. The obstruction includes one or more materials that reduce the strength of the wireless microwave signals passing through the predetermined physical obstruction. For example, the materials may include concrete, rebar, a combination of concrete and rebar, or other lossy material(s) in the microwave spectrum, alone or in combination. The first MIMO antenna is positioned to transmit and receive the wireless microwave signals through the obstruction. A second microwave-frequency MIMO antenna is positioned on an opposite side of the obstruction from the first MIMO antenna. The second MIMO antenna is configured to transmit and receive the wireless microwave signals through the obstruction to and from the first MIMO antenna. The second MIMO antenna is coupled to a second RF transceiver and they are configured to compensate for the path loss experienced by the microwave signals passing through the obstruction so as to maintain the data rate. The wireless microwave signals are then transmitted through the obstruction from the first MIMO antenna to the second MIMO antenna.

The foregoing summary does not define the limits of the appended claims. Other aspects, embodiments, features and advantages will be or will become apparent to one with skill in the art upon examination of the following figures and detailed description. It is intended that all such additional features, embodiments, aspects, and advantages be included within this description and be protected by the accompanying claims.

### BRIEF DESCRIPTION OF DRAWINGS

It is to be understood that the drawings are solely for purpose of illustration and do not define the limits of the appended claims. Furthermore, the components in the figures are not necessarily to scale. In the figures, like reference numerals designate corresponding parts throughout the different views.

FIG. 1 is a first schematic perspective view of a first exemplary wireless communication system.

FIG. 2 is a schematic view of an example of a wireless local area network (WLAN) provided to multiple floors (levels) within a building, where the WLAN may employ the panels shown in FIG. 1.

FIG. 3 is a detailed schematic perspective view of the antennas included in the wireless communication system of FIG. 1.

FIG. 4 is a schematic view of an exemplary networked communication system that includes wireless millimeter wave nodes linked to microwave panels that are configured to wirelessly communicate through a lossy physical obstruction.

### DETAILED DESCRIPTION

The following detailed description, which references to and incorporates the drawings, describes and illustrates one or more examples of a wireless communication network and method, as well as exemplary components of such wireless communication network(s). These examples, offered not to limit, but only to exemplify and teach embodiments of the components, apparatuses, systems, networks, and methods, are shown and described in sufficient detail to enable those skilled in the art to practice what is claimed. Thus, where appropriate to avoid obscuring the invention, the description may omit certain information known to those of skill in the art. The disclosures herein are examples that should not be read to unduly limit the scope of any patent claims that may eventually be granted based on this application.

The word “exemplary” is used throughout this application to mean “serving as an example, instance, or illustration.” Any system, apparatus, method, device, technique, feature or the like described herein as “exemplary” is not necessarily to be construed as preferred or advantageous over other features.

As used in this specification and the appended claims, the singular forms “a,” “an,” and “the” include plural referents unless the content clearly dictates otherwise.

Also, the use of “or” means “and/or” unless stated otherwise. Similarly, “comprise,” “comprises,” “comprising” “include,” “includes,” and “including” are interchangeable and not intended to be limiting.

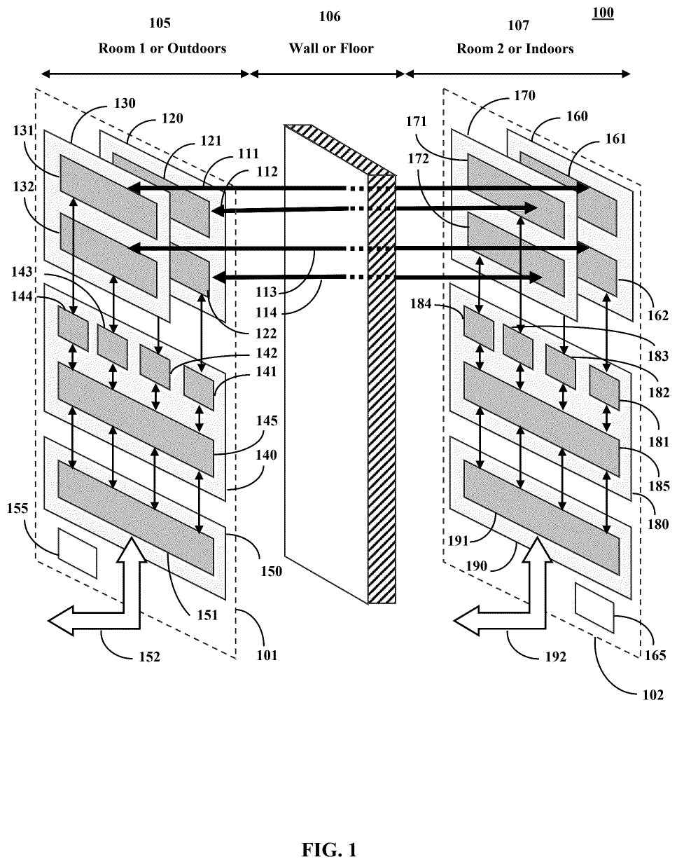

FIG. 1 is a schematic illustration of an exemplary wireless communications system 100. The system 100 includes two apparatuses (e.g., panels 101 and 102), each configured to send microwave signals over a wireless link through one or more obstructions, such as walls, barriers, other structures and/or unobstructed paths (free space), or the like. Path loss, or path attenuation, is the reduction in power density (attenuation) of an electromagnetic wave as it propagates through space. Microwave signals can and do pass through certain obstructions, such as building walls, but the signal strength or quality may be degraded depending on the material and the thickness of the material. Degradation can be caused by attenuation, reflection and/or other physical processes occurring between the obstruction and the wireless signal. Likewise, moisture content within the air (humidity) and the obstructions (such as concrete) also contributes to a reduction in received signal power (e.g., path loss). The wireless communication system 100 allows microwave signals to pass efficiently and reliably through one or more obstructions with the signals experiencing reduced degradation. Accordingly, the system 100 may improve the reliability of wireless microwave communication across increased line of sight range, and through obstructions, such as those found within buildings or other manmade structures.

Common building materials such as concrete, rebar, and structures using a combination of rebar and concrete generally present severe barriers to wireless microwave communications because they do not allow wireless microwave frequency communication signals to effectively pass through them. The measured loss of a typical concrete wall is around 6 dB/inch with no rebar and around 7 dB/inch with rebar at 5.9 GHz to 7 GHz. In some conventional wireless networks using microwave and higher frequency spectrums, optical or wire communications cables are routed through penetrations in the concrete structures to allow communications through the concrete obstruction. However, forming these penetrations and installing cabling may be expensive and time consuming. The system 100 may eliminate the need for barrier penetrations and cabling in many applications.

The system 100 includes a first panel 101 with a wireless radio-frequency (RF) transceiver module 140 mounted to the first panel 101, and an antenna 120, 130 mounted to the first panel 101, operatively coupled to the wireless transceiver 140. The system 100 also includes a second separate panel 102, not attached to the first panel 101, which may be locatable behind an obstruction 106 relative to the first panel 101. The second panel 102 may include at least some of the same components as the first panel 101 (e.g. an RF transceiver module 180, interface 190, controller 165, and antenna 160, 170), and it may provide transmit and receive operations for a wireless communications link 111, 112, 113, 114 to the first panel 101.

In some embodiments, the panels 101, 102 include substantially planar or flat structures for mounting electrical components such as the RF transceivers 140, 180, antennas 120, 130, 160, 170, respectively, as well as other components. For example, the panels 101, 102 may include printed circuit boards (PCBs) or other substrates of suitable materials, such as a glass-reinforced epoxy resin laminate, ceramic material, or the like. In other embodiments, panels 101, 102 may include the flexible structures for mounting components, such as flexible PCBs. The thicknesses of the panels 101, 102 may vary depending on the components used. In some embodiments, the panels 101, 102 are not flat or planar and may take other shapes. Also, the panels 101, 102 may each be enclosed in separate housings (not shown), or incorporated into other devices.

In the example of FIG. 1, the first panel 101 is mounted on one side of an obstruction, such as a wall 106, in room 1 105 and the second panel 102 is mounted on the opposite side of the wall or floor 106 in room 2 107. The first and second panels 101, 102 may be generally aligned with each other (e.g., the antennas 120, 130 face antennas 160, 170 and surface area overlap with them by at least 80%). The panels 101, 102 may each include any suitable means for attaching them to the wall 106, including hooks, adhesives, mounting brackets, fasteners such as screws or nails, eyelets, wires or the like. Furthermore, panels 101 or 102 may be mounted from overhead, such as from the ceiling, or mounted atop a floor stand or tripod (with no wall contact in either case).

The first panel 101 includes a first set of antennas 120, directed toward the wall 106. The first panel 101 also includes a second set of antennas 130, directed toward the wall 106. Two antennas 121 and 122 within the first set 120 and the two antennas 131 and 132 within the second set 130 operate as the elements for a 4×4 multiple-input multiple-output (MIMO) antenna. Each antenna 121, 122, 131, and 132, may operate at one of four polarizations, 0°, +45°, +90°, and −45°, respectively. MIMO operation increases the data rate or throughput (in this case by 4×) without increasing the required spectrum bandwidth.

The second panel 102 includes a first set of antennas 170, directed toward the wall 106. The second panel 102 also includes a second set of antennas 160, directed toward the wall 106. Two antennas 171 and 172 within the first set 170 and the two antennas 161 and 162 within the second set 160 operate as the elements for a 4×4 multiple-input multiple-output (MIMO) antenna. Each antenna 171, 172, 161, and 162, may operate at one of four polarizations, 0°, +45°, +90°, and −45°, respectively. MIMO operation increases the data bandwidth (in this case by 4×) without increasing the required spectrum bandwidth.

The example system 100 shown in FIG. 1 uses 4×4 MIMO antennas 120,130 and 160,170. However, some embodiments may use MIMO antennas having a different number of elements, for example, 2×2, 8×8 MIMO or other configurations.

Each of the 4×4 MIMO antennas 120,130 and 160,170 may have a gain selected to adequately and effectively penetrate the obstruction 106 so as to maintain a desired data rate of the wireless communication signals 111, 112, 113, 114 passing between the panels 101, 102. In some configurations, the 4×4 MIMO antennas 120,130 and 160,170 may each have a gain of about 16 dBi or more. Antennas with gains less than 16 dBi may be used in other configurations. In some embodiments, the MIMO antennas 120,130 and 160,170 may be commercial-off-the-shelf (COTS) devices.

The RF modules 140, 180 in each panel 101, 102 process wireless microwave signals received and transmitted between the panels 101, 102 by the 4×4 MIMO antennas 120,130 and 160,170. In operation, the signals 111, 112, 113, 114 of the wireless links are received/transmitted by RF components 141, 142, 143, 144 within the RF module 140 of the first panel 101. Similarly, the signals 111, 112, 113, 114 are received/transmitted by the RF components 181, 182, 183, 184 within the RF module 180 of the second panel 102. In some embodiments, the RF modules 140, 180 and their respective components 141, 142, 143, 144, 145 and 181, 182, 183, 184, 185 may be COTS Wi-Fi modules.

Signals received at the first panel 101 are amplified by LNAs (low noise amplifiers) (not shown), down converted to baseband (BB) frequencies and demodulated by a baseband processor 145 to recover the data transmitted over the wireless links 111,112, 113, 114. Conversely, data transmitted across each wireless link by the first panel 101 are first modulated by the baseband processor 145, upconverted to a specified RF frequency, amplified by PAs (power amplifiers) (not shown) and routed to the antennas 121, 122, 131, 132 within the antenna modules 120 and 130 of the first panel 101. The same procedure is used by the second panel 102, using RF components 181, 182, 183, 184 and baseband processor 185 within the RF module 180, for transmitting and receiving wireless data over the wireless links 111, 112, 113, 114.

The modulation, coding scheme and channels used by the transceiver modules 140,180 to generate wireless signals 111, 112, 113, 114 may be specifically configured and set to improve the penetration of the signals 111, 112, 113, 114 through the obstruction 106 and to meet other requirements. For example, the modulation, coding scheme and channels of the signals 111, 112, 113, 114 may be set to a predefined configuration that supports or maintains a certain desired data rate of the wireless signals 111, 112, 113, 114. In some embodiments, the transceiver modules 140,180 are configured so that the signals 111, 112, 113, 114 are in the 5 GHz (Wi-Fi 6) and/or 6 GHz (Wi-Fi 7 or Wi-Fi 6E) bands and are modulated and coded using certain QAM modulation(s) and channel bandwidths (e.g., 80 MHz, 160 MHz, 320 MHZ or the like). For example, a QAM64 2/3 scheme using 160 MHz channels may be used. In addition, specific Wi-Fi channels may be selected, for example, channel 161 of Wi-Fi 6 at 5.805 GHz may be selected. The foregoing selections may achieve a desired data rate of about 2.3 Gbps (±10%) through concrete block(s) of about 10 inches thickness. Other coding schemes from BPSK up to 4096 QAM and channel sizes from 40 MHz up to 320 MHz, may be used in some configurations.

Additionally/alternatively, the modulation, coding scheme and channels used by the transceiver modules 140,180 may be selected to modify or limit the EIRP (effective isotropic radiated power) of the panels 101, 102. For example, the aforementioned QAM64 2/3 scheme using 160 MHz channels scheme may be used to limit the EIRP to less than 33 dBm, and in some configurations less than 30 dBm, at the 6 GHz Wi-Fi band.

Although the signals 111, 112, 113, 114 of the wireless links passing through the wall 106 may be any suitable frequency band, in the example shown, the signals are typically operated in the 5 GHz (Wi-Fi 6) and/or 6 GHz (Wi-Fi 7 or Wi-Fi 6E) bands in accordance with industry standards, for example, IEEE 802.11ax and IEEE 802.11be. Within the bands, multiple systems operating in different channels have advantages in that they may increase available bandwidth (higher data rates) and improve the reliability and compatibility of multiple systems operating within the same location. Orthogonal frequency-division multiplexing (OFDM) may be used to mitigate the effects of severe frequency attenuation within the signal bandwidth. In some embodiments, single carrier transmission may alternatively/additionally be used by the panels 101, 102.

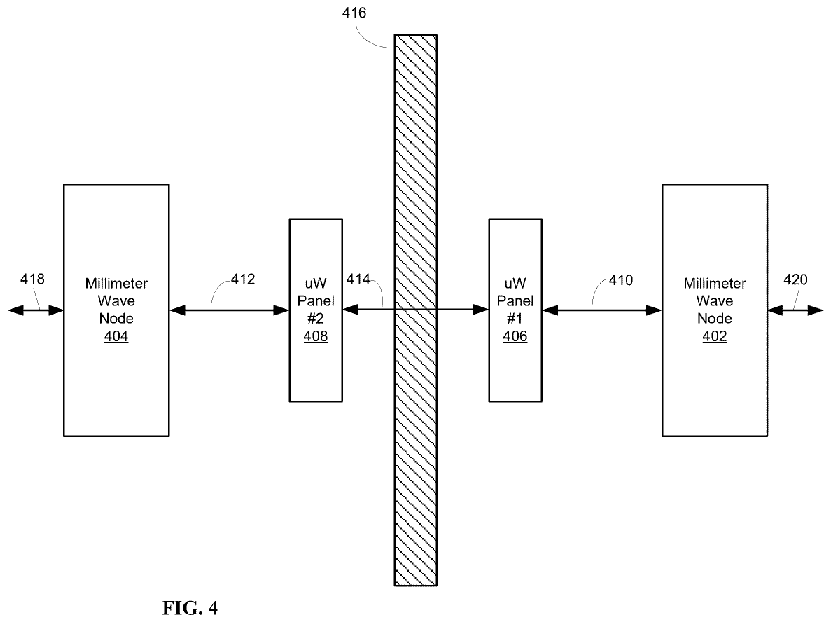

Each of the panels 101, 102 may also include local wireless and/or cable interfaces 150, 190 that include, for example, access control units (ACUs) 151, 191, respectively, for communicating with one or more terminal networked devices (not shown) or other network nodes (refer to FIG. 4) in room 1 105, and room 2 107, respectively. The external links 152, 192 to the terminal devices or nodes may be any suitable wireless or wired link, for example Ethernet. The interfaces 150, 190 may be made up of COTS components.

The ACUs 151, 191 may each include certain functions and components that serve to manage and deliver data packets, e.g., Ethernet packets, of information transferred by the wireless communication links 111, 112, 113, 114. For example, the components of each ACU 151, 191 may include an Ethernet packet manager and one or more access modules, e.g., a wireless access module and/or a cable access module. Software/firmware may be used to control communications between the modules and the packet manager in each ACU 151, 191. The Ethernet packet managers may each be a commercially-available Ethernet switch, and the access modules may each include commercially-available chipsets and/or software/firmware that implement standards-based local communication protocols, such as one or more of the IEEE 802.11 Wi-Fi standards or IEEE 802.3 Ethernet cable standards. Each of the ACUs 151, 191 may also include one or more antennas and/or cable ports (not shown).

The panels 101, 102 may be configured to operate in either Time Division Duplexing (TDD) or Frequency Division Duplexing (FDD) modes. For example, in some implementations, the four antennas 121, 122, 131, and 132, transmit concurrently for a period of time. This is followed by a period of time in which the four antennas 121, 122, 131, and 132, receive concurrently. The antennas 161, 162, 171, and 172 of the second panel 102 may be configured in the same manner. Essentially, each of the antennas 121, 122, 131, 132, 161, 162, 171, 172 is adapted to emit a microwave signal to a specified channel within a frequency band. The same antenna is adapted to receive a microwave signal within the specified channel of the frequency band. Thus, the emitted signal and the received signal may share the same specified channel and operate in half-duplex to reduce the spectrum bandwidth. This type of bi-directional operation is known as Time Division Duplexing (TDD). This reduces the complexity of the radio frequency (RF) circuitry in the panels 101, 102.

In other implementations the four antennas 121, 122, 131, and 132 may transmit and receive simultaneously to the four antennas 161, 162, 171, and 172 within the first set of antennas 170 and the second set of antennas 160 of the second panel 102. The antennas may emit and receive signals simultaneously on separate channels and operate in full-duplex to increase the data rate compared to using a shared channel. This type of bi-directional operation is known as Frequency Division Duplexing (FDD).

Each of the panels 101,102 includes a controller 155, 165, respectively. Each of the controllers 155, 165 may be coupled to other components (e.g., transceivers, 140, 180 and interfaces 150, 190) within its respective panel by way of busses (not shown). The controllers 155, 165 included in each of the panels 101, 102 may be any suitable means for controlling the operation of the respectively panel, as well as the system 100. For example, each controller 155, 165 may include one or more processors for executing instructions or code, such as one or more digital signal processors (DSPs), general purpose microprocessors, application specific integrated circuits (ASICs), field programmable logic arrays (FPGAs), or other equivalent integrated or discrete logic circuitry. The controllers 155, 165 may also include memory. The memory and processor may be combined as a single chip. In some embodiments, the controllers 155, 165 may be commercially-available cores, such as the ARM Cortex a53 or a72.

The functions of the controller may be implemented in hardware, software, firmware, or any suitable combination thereof. If implemented in software, the functions may be stored as one or more instructions or code on a computer-readable medium (e.g., memory) and executed by a hardware-based processing unit (e.g., a processor). Computer-readable media may include any computer-readable storage media, including data storage media, which may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disc storage, magnetic disk storage, or other magnetic storage devices, flash memory, or any other medium that can be used to store desired program code in the form of instructions or data structures and that can be accessed by a computer. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

In some embodiments, the controllers 155, 165 in each panel 101, 102 may be configured so that fully-duplexed wireless communication paths 111, 112, 113, and 114 are available through the wall 106 by way of the antennas 121, 122, 131, 132, 161, 162, 171, and 172 and the transceivers 140 and 180. In other embodiments, the controllers 155, 165 in each panel 101, 102 may be configured so that half-duplexed wireless communication paths 111, 112, 113, and 114 are available through the wall 106 by way of the antennas 121, 122, 131, 132, 161, 162, 171, and 172 and the transceivers 140 and 180. In some embodiments, the controllers 155, 165 allow the panels 101, 102 to be selectively operated in a half-duplex mode or a full-duplex mode.

The controllers 155, 165 may be configured to manage data transfer and flow between the interfaces 150, 190 and the transceivers 140, 180, respectively. In certain modes of operation, the controllers in each panel 101, 102 may be configured so that the system 100 acts as a wireless repeater, capable of wirelessly passing information between rooms 1 and 2 through wall 106.

In operation, data may flow from the first panel 101 to the second panel 102 in the following manner. Digital data is received at the interface 150. The data from the interface 150 may be transferred from interface 150 to the wireless transceiver 140 by the controller 155. The transceiver 140 converts the digital baseband signal to a microwave signal and emits the microwave signal through the antenna 120, 130. The emitted microwave signal is received by the antenna 160, 170 in the second panel 102 and after passing through wall obstruction 106 between the first and second panels 101, 102. The microwave signals received at the antenna 160, 170 of the second panel 102 is coupled to the transceiver 180. The transceiver 180 converts the microwave signal back to a digital baseband signal. The digital baseband is transmitted to the interface 190 within the second panel 102.

Digital data from the local interface 190 within the second panel 102 may be transferred to the local interface 150 of the first panel 101 though the same obstruction(s) (e.g., wall or floor 106) in the same manner as the data transfer from the first panel 101 to the second panel 102. The network may be extended or cascaded by connecting the local interfaces 150, 190 of the panels 101, 102 to the local interface of other panels (not shown). An example of extending the network in shown in FIG. 4.

In some circumstances, one or both of the panels 101, 102 may be located a certain minimum distance from the obstruction 106 to avoid near field interference from the antennas 120, 130, 160, 170. For example, the antenna-to-antenna distance between the antenna 120, 130 and antenna 160, 170 may be one foot or more to avoid near field interference.

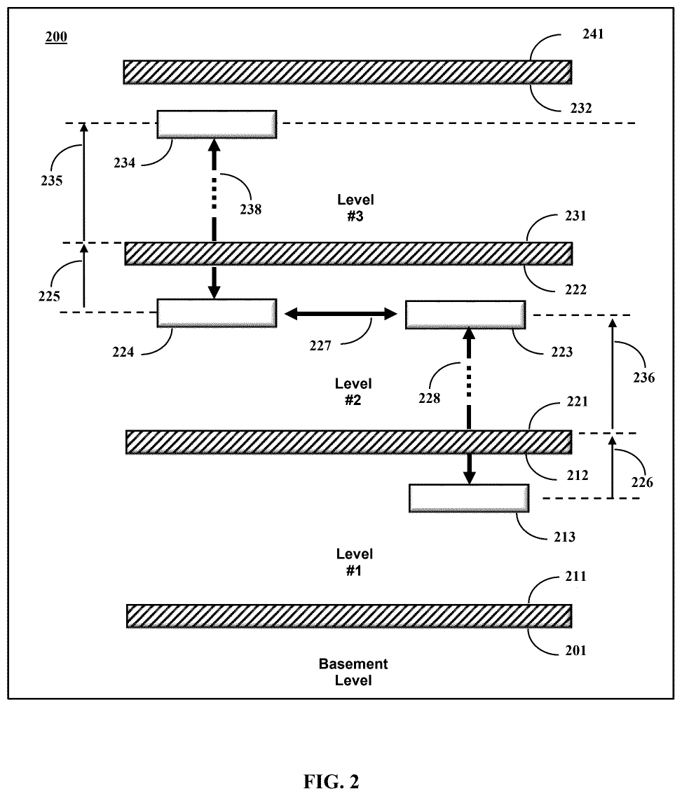

FIG. 2 is an example of a WLAN (wireless local area network) located at three levels of a building 200 using wireless links 228, 238 to pass the RF signals through floor 221, 231 and ceiling 212, 222 obstacles. Panels 213, 223, 224, 234 are mounted to the ceilings 212, 222, 232 of the different building levels (floors). The ceiling 201 of a basement level and floor 241 of a fourth level are shown for illustration but not used in this example. The panels 213, 223, 224, 234 may include panels 101, 102 of FIG. 1.

A first wireless link 228 connects the first panel 213 to the second panel 223 for routing data to/from Level 1 and Level 2 in the building 200. Local LANs or WLANs may be attached to either of the panels 213, 223 by way of their local interfaces. This extends the WLAN to additional floors or levels in the building 200 that would otherwise require physical penetration of the floors 221, 231, 241 and ceilings 212, 222, 232 to route wire or optical cables between the levels. The connection between the second panel 223 and the third panel 224 on level 2 may be a wired connection 227 using the panels' local interfaces since no penetration of the floors and ceilings is required. Alternatively, the connection 227 may be a wireless link using local interfaces of the panels 223, 224.

A second wireless link 238 connects the third panel 224 to a fourth panel 234 on the third level. The fourth panel 234 may be attached to the ceiling 232. This extends the WLAN to the third level of the building 200. Although not shown, the WLAN can be extended further with additional panels. FIG. 2 shows an example in-building network that can be extended for more extensive networks including alternative network implementations through walls and/or additional floors.

Frequency and power planning is performed to minimize interference between the panels. For example, the total link attenuation for first wireless link 228 is determined by the combining the wireless signal attenuation caused by the ceiling 212 and floor 221 and free-space path losses (FSPLs) 226 from the panel 213 to the ceiling 212 and the FSPL 236 from the floor 221 to the panel 223. The large gain of the antennas within the panels may allow the ability to penetrate concrete floors up to 16 inches and at least 10 inches. Floors and ceiling with corrugated metal construction may be penetrated. The total link attenuation may be similarly determined for the second wireless link 238, where the total link attenuation consists of the attenuation of the ceiling 222, the floor 231 and the FSPLs 225, 235. The frequencies for the first and second wireless links 228, 238 may be different to avoid interference and degradation between the wireless links 228, 238.

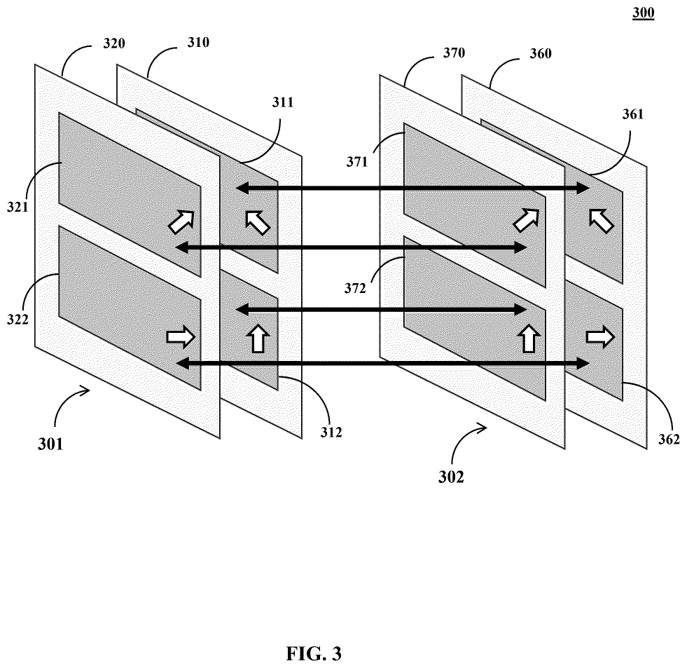

FIG. 3 is a detailed view of an example 4×4 MIMO antenna system 300 that includes antennas 301, 302, which may be included in the panels 101, 102 shown in FIG. 1, respectively. A first antenna 301 includes a first set 310 of antennas (elements) 311, 312 and a second set 320 of antennas (elements) 321, 322 includable within the first panel 101. The first and second sets of antenna 310, 320 may be an example used as the sets of antennas 120, 130, respectively, in the first panel 101. A separate second antenna 302 includes a first set 370 of antennas (elements) 371, 372 and a second set 360 of antennas (elements) 361, 362 includable within the second panel 102. The first and second sets of antenna 370, 360 may be an example used as the sets of antennas 170, 160, respectively, in the second panel 102.

In order to provide a compact implementation and reduce phase distortion at close separation between panels 101, 102, the first set 310 and the second set 320 are formed on substrates that are stacked substantially parallel to each other so that the second set 320 radiates through the substrate (e.g., a printed circuit board (PCB)) of the first set 310 of antennas. Likewise, the first set 370 and the second set 360 are each formed on substrates that are stacked substantially parallel to each other so that the second set 360 radiates through the substrate (e.g., a PCB) of the first set 370 of antennas. The material for the antenna substrates may be selected to reduce the signal loss to a negligible amount for a wireless signal passing to/from the set second 320 through the first set 310 (and set 360 through set 370). Each substrate may be substantially flat or planar (does not deviate more than 10% of the longest width/height dimension). The antenna design may not include a ground plane on the PCB. An example of such an antenna is a patch antenna. Each antenna 311, 312, 321, and 322 within the first panel 102 radiates at different polarizations to provide the spatial diversity required in the MIMO implementation. For example, each antenna 311, 312, 321, and 322 may operate at one of four polarizations, 0°, +45°, +90°, and −45°, respectively. Similarly, each antenna, 361, 362, 371, and 372 within the second panel receives/transmits at the corresponding polarizations. The example MIMO implementation illustrated in FIG. 3 provides robust transmission through obstacles, such as those made by concrete, by providing multiple diverse paths.

FIG. 4 is a schematic view of an exemplary networked communication system 400 that includes wireless millimeter wave nodes 402, 404 linked to microwave (μW) panels 406, 408, which are each configured to wirelessly communicate microwave signals 414 through a lossy physical obstruction 416. The panels 406, 408 may include the panels 101, 102 of FIG. 1 being configured as described herein to transfer microwave signals through the obstruction 416. The obstruction 416 may be any of those described herein. The millimeter wave nodes 402, 404 may be connected to the first panel 402 and the second panel 406, respectively, with wired Ethernet connections 410, 412 using, for example, interfaces 150, 190 described in connection with FIG. 1.

The millimeter wave nodes 402, 404 may be any wireless millimeter wave network node, such as any of those described in the '850 patent, which is hereby incorporated by reference in its entirety. The millimeter wave nodes 402, 404 may be configured to communicate with one or more other network nodes (not shown) using wireless millimeter wave links 418, 420.

The panels 406, 408 may be configured so that the data rate of the wireless microwave signals 414 may substantially be the same as a data rate of the wireless millimeter wave signals 418, 420. For example, the panels 406, 408 may be configured to support a data rate of about 2.3 Gbps passing through the obstruction 416.

It should be understood that, depending on the example, certain acts or events of any of the methods described herein can be performed in a different sequence, may be added, merged, or left out altogether (e.g., not all described acts or events are necessary for the practice of the method). Moreover, in certain examples, acts or events may be performed concurrently, rather than sequentially. In addition, while certain aspects of this disclosure are described as being performed by a single module or component for purposes of clarity, it should be understood that the functions described in this disclosure may be performed by any suitable combination of components or modules associated with a wireless data communication network or system.

The foregoing description is illustrative and not restrictive. Although certain exemplary embodiment(s) have been described, other embodiments, combinations and modifications involving the invention will occur readily to those of ordinary skill in the art in view of the foregoing teachings. Therefore, the invention is to be limited only by the following claims, which cover one or more of the disclosed embodiments, as well as all other such embodiments and modifications when viewed in conjunction with the above specification and accompanying drawings.

What is claimed is:

1. An apparatus, comprising:
a microwave-frequency multiple-input multiple-output (MIMO) antenna configured to transmit and receive wireless microwave signals through a predetermined physical obstruction, wherein the physical obstruction includes one or more materials that reduce the strength of the wireless microwave signals passing through the predetermined physical obstruction; and
a radio frequency (RF) transceiver, operatively coupled to the MIMO antenna, configured to process the wireless microwave signals transmitted and received by the MIMO antenna;
wherein the MIMO antenna and the RF transceiver are configured to compensate for path loss experienced by the microwave signals passing through the predetermined physical obstruction so as to maintain a predetermined data rate of the wireless microwave signals.

2. The apparatus of claim 1, wherein the materials include a material selected from the group consisting of concrete, rebar, and a combination of concrete and rebar.

3. The apparatus of claim 1, wherein the microwave-frequency MIMO antenna is part of a 4×4 MIMO antenna.

4. The apparatus of claim 1, wherein in the MIMO antenna includes four antennas that each operate at one of four distinct polarizations, respectively.

5. The apparatus of claim 4, wherein the four distinct polarizations include 0°, +45°, +90°, and −45°.

6. The apparatus of claim 1, wherein the wireless microwave signals are in a band selected from the group consisting of the 5 GHz band and 6 GHz band defined by IEEE 802.11ax or IEEE 802.11be.

7. The apparatus of claim 6, wherein the RF transceiver is configured to modulate and code the wireless microwave signals using a QAM64 2/3 scheme and one or more 160 MHz channels.

8. A communication system, comprising:
a first apparatus including:
a first microwave-frequency multiple-input multiple-output (MIMO) antenna configured to transmit and receive wireless microwave signals through a predetermined physical obstruction, wherein the physical obstruction includes one or more materials that reduce the strength of the wireless microwave signals passing through the predetermined physical obstruction; and
a first radio frequency (RF) transceiver, operatively coupled to the first MIMO antenna, configured to process the wireless microwave signals transmitted and received by the first MIMO antenna;
wherein the first MIMO antenna and the first RF transceiver are configured to compensate for path loss experienced by the microwave signals passing through the predetermined physical obstruction so as to maintain a predetermined data rate of the wireless microwave signals; and
a second apparatus located on an opposite side of the predetermined physical obstruction from the first apparatus, the second apparatus including:
a second microwave-frequency MIMO antenna configured to transmit and receive the wireless microwave signals through the predetermined physical obstruction; and
a second radio frequency (RF) transceiver, operatively coupled to the second MIMO antenna, configured to process the wireless microwave signals transmitted and received by the second MIMO antenna;
wherein the second MIMO antenna and the second RF transceiver are configured to compensate for the path loss experienced by the microwave signals passing through the predetermined physical obstruction so as to maintain the predetermined data rate of the wireless microwave signals.

9. The communication system of claim 8, further comprising:
a network node, operatively coupled to either the first apparatus or the second apparatus, the network node being configured to communicate with one or more other network nodes using wireless millimeter wave signals.

10. The communication system of claim 9, wherein the network node is connected to either the first apparatus or the second apparatus with a wired Ethernet connection.

11. The communication system of claim 9, wherein the predetermined data rate of the wireless microwave signals is substantially the same as a data rate of the wireless millimeter wave signals.

12. The communication system of claim 8, wherein the first microwave-frequency MIMO antenna and the second microwave-frequency MIMO antenna are a 4×4 MIMO antenna.

13. The communication system of claim 8, wherein the first microwave-frequency MIMO includes four antennas each operating at one of four distinct polarizations, respectively.

14. The communication system of claim 13, wherein the four distinct polarizations include 0°, +45°, +90°, and −45°.

15. The communication system of claim 13, wherein the second microwave-frequency MIMO includes four antennas each operating at one of four distinct polarizations, respectively.

16. The communication system of claim 15, wherein the four distinct polarizations include 0°, +45°, +90°, and −45°.

17. The communication system of claim 8, wherein the wireless microwave signals are in a band selected from the group consisting of the 5 GHz band and 6 GHz band defined by either IEEE 802.11ax or IEEE 802.11be.

18. The communication system of claim 17, wherein the RF transceiver is configured to modulate and code the wireless microwave signals using a QAM64 2/3 scheme and 160 MHz channels.

19. A method of wireless communication, comprising:
configuring a first microwave-frequency multiple-input multiple-output (MIMO) antenna and a first RF transceiver, operatively coupled to the first microwave-frequency MIMO antenna, to compensate for path loss experienced by one or more microwave signals passing through a predetermined physical obstruction so as to maintain a predetermined data rate, wherein the physical obstruction includes one or more materials that reduce the strength of the wireless microwave signals passing through the predetermined physical obstruction;
positioning the first microwave-frequency MIMO antenna to transmit and receive the wireless microwave signals through the predetermined physical obstruction;
configuring a second microwave-frequency MIMO antenna and a second RF transceiver, operatively coupled to the second microwave-frequency MIMO antenna, to compensate for the path loss experienced by the microwave signals passing through the predetermined physical obstruction so as to maintain the predetermined data rate;
positioning the second microwave-frequency MIMO antenna, on an opposite side of the predetermined physical obstruction from the first microwave-frequency MIMO antenna, to transmit and receive the wireless microwave signals through the predetermined physical obstruction; and
transmitting the wireless microwave signals through the predetermined physical obstruction from the first microwave-frequency MIMO antenna to the second microwave-frequency MIMO antenna.

20. The method of claim 19, wherein the materials include a material selected from the group consisting of concrete, rebar, and a combination of concrete and rebar.
